(19) United States
(12) Patent Application Publication
(10) Pub. No.: US 2025/0157043 A1
(43) Pub. Date: May 15, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventors: Satoshi MATSUI, Kyoto (JP); Tadamasa TOMA, Osaka (JP); Minami NAKA, Osaka (JP)

(73) Assignee: PANASONIC INTELLECTUAL PROPERTY MANAGEMENT CO., LTD., Osaka (JP)

(21) Appl. No.: 19/025,088

(22) Filed: Jan. 16, 2025

Related U.S. Application Data
(63) Continuation of application No. PCT/JP2023/025801, filed on Jul. 12, 2023.
(60) Provisional application No. 63/368,955, filed on Jul. 20, 2022.

(30) Foreign Application Priority Data
Jun. 19, 2023 (JP) 2023-100247

(51) Int. Cl. G06T 7/10

(52) U.S. Cl. CPC G06T 7/10

(57) ABSTRACT

An image processing device acquires an image captured by a camera, executes mask processing of creating a mask image in which an area outside a capturable area in the image is masked, determines whether or not the mask processing is executed, and transmits the mask image when it is determined that the mask processing is executed.

### FIELD OF INVENTION

The present disclosure relates to a technique of masking an area other than a plurality of capturable areas in an image.

### BACKGROUND ART

For example, Patent Literature 1 discloses a video control device in which a work area is set with a capturable area in which video sharing with a remote support worker is permitted, and a masking video in which a work area that is not the capturable area is masked is transmitted to a remote terminal for the remote support worker. A conventional video control device detects a marker included in video data, extracts marker information indicating a capturable area from the detected marker, determines a video area determined to be outside the capturable area in the video data as an unshareable video area, and masks the unshareable video area to generate a masked video.

However, in the above-described conventional technique, there is a possibility that confidential information leaks, and further improvement has been required.

Patent Literature 1: JP 2021-150866 A

### SUMMARY OF THE INVENTION

The present disclosure has been made to solve the above problem, and an object of the present disclosure is to provide a technique capable of preventing confidential information from leaking.

An information processing method according to the present disclosure is an information processing method in a computer, the information processing method including acquiring an image captured by a camera, executing mask processing of creating a mask image in which an area outside a capturable area in the image is masked, determining whether or not the mask processing is executed, and transmitting the mask image when it is determined that the mask processing is executed.

According to the present disclosure, leakage of confidential information can be prevented.

### BRIEF DESCRIPTION OF THE DRAWINGS

FIG. 1 is a diagram illustrating an example of a configuration of a work support system according to a first embodiment of the present disclosure.

FIG. 2 is a diagram illustrating an example of a work space in the first embodiment.

FIG. 3 is a diagram illustrating an example of a configuration of an image processing device according to the first embodiment.

FIG. 4 is a diagram illustrating an example of an image captured by a camera in a manner that all markers appear in the first embodiment.

FIG. 5 is a diagram illustrating an example of a mask image created based on the image illustrated in FIG. 4 in the first embodiment.

FIG. 6 is a first flowchart for explaining work support processing by the image processing device according to the first embodiment of the present disclosure.

FIG. 7 is a second flowchart for explaining the work support processing by the image processing device according to the first embodiment of the present disclosure.

FIG. 8 is a diagram illustrating an example of a configuration of the image processing device according to a second embodiment.

FIG. 9 is a first flowchart for explaining the work support processing by the image processing device according to the second embodiment of the present disclosure.

FIG. 10 is a second flowchart for explaining the work support processing by the image processing device according to the second embodiment of the present disclosure.

### DETAILED DESCRIPTION

### Knowledge Underlying Present Disclosure

In order for a worker in a site to efficiently receive business support from a worker in a remote place, it is effective to share a video capturing a situation at the site with the worker in the remote place.

When a video is transmitted to a remote place, there is a possibility that confidential information appears in the video. In view of the above, in order to prevent confidential information from being leaked to the outside by video transmission, processing of identifying an object for which video transmission is possible or an object that is confidential information and masking an area corresponding to confidential information in a video is performed.

For example, a worker in a site arranges a plurality of markers in a manner surrounding an area that can be transmitted via video, that is, an area not including confidential information. A plurality of markers in a captured video are recognized, and an area outside a capturable area surrounded by a plurality of recognized markers is masked, so that it is possible to prevent confidential information from leaking.

However, a camera is activated at an optional timing by a worker. For this reason, if transmission of video is started in a state where a mask processing function for concealing confidential information is not operated at a timing when the video is output from a camera, there is a possibility that the video including the confidential information is transmitted to a terminal at a remote place, and there is a possibility that the confidential information leaks.

In the above-described conventional technique, masked video data is transmitted to a remote terminal, but it is not determined whether or not the mask processing is reliably executed, and there is a possibility that confidential information leaks.

To solve the above problems, a technique below is disclosed.
(1) An information processing method according to one aspect of the present disclosure is an information processing method in a computer, the information processing method including acquiring an image captured by a camera, executing mask processing of creating a mask image in which an area outside a capturable area in the image is masked, determining whether or not the mask processing is executed, and transmitting the mask image when it is determined that the mask processing is executed.

According to this configuration, after the mask processing of creating a mask image in which an area outside a capturable area in an image is masked is executed, it is determined whether or not the mask processing is executed. Then, when it is determined that the mask processing is executed, the created mask image is transmitted. Therefore, leakage of confidential information can be prevented.
(2) In the information processing method according to (1) above, the mask processing may include recognizing a plurality of markers included in the image, and creating a mask image in which an area outside the capturable area surrounded by the plurality of markers that are recognized in the image is masked.

According to this configuration, as a plurality of markers are arranged so as to surround an area not including confidential information, a capturable area in an image can be easily identified, and leakage of the confidential information can be prevented.
(3) The information processing method according to (1) or (2) above may further include turning on a flag indicating that the mask image can be transmitted after the mask processing is first executed, in which in the determining whether or not the mask processing is executed, whether or not the flag is on may be determined, and when it is determined that the flag is on, it may be determined that the mask processing is executed.

According to this configuration, after the mask processing is executed for the second and subsequent times, it is determined whether or not a flag indicating that a mask image can be transmitted is on, and when it is determined that the flag is on, the mask image is transmitted. Therefore, by determining whether or not a flag indicating that a mask image can be transmitted is on, it is possible to easily determine whether or not the mask processing is executed.
(4) The information processing method according to (1) or (2) above may further include displaying the mask image that is created after the mask processing is first executed, receiving an instruction indicating whether or not the mask processing is normally executed input by a worker, and turning on a flag indicating that the mask image can be transmitted when an instruction indicating that the mask processing is normally executed input by the worker is received, in which in the determining whether or not the mask processing is executed, whether or not the flag is on may be determined, and when it is determined that the flag is on, it may be determined that the mask processing is executed.

According to this configuration, a worker checks whether or not the mask processing is normally executed by viewing a displayed mask image, and thus, it is possible to reliably prevent leakage of confidential information.
(5) The information processing method according to (4) above may further include turning off the flag when an instruction indicating that the mask processing is not normally executed input by the worker is received, in which, in the determining whether or not the mask processing is executed, whether or not the flag is on may be determined, and when it is determined that the flag is off, it may be determined that the mask processing is not executed, and in the transmitting a mask image, when it is determined that the mask processing is not executed, the mask image may not be transmitted.

According to this configuration, when an instruction indicating that the mask processing is not normally executed input by a worker is received, the flag is turned off. Then, when it is determined that the flag is off after the mask processing is executed for the second and subsequent times, a mask image is not transmitted.

Therefore, when it is determined by a worker that the mask processing is not normally executed, the flag is turned off, and a mask image is not transmitted even if the mask processing is executed. Therefore, it is possible to reliably prevent leakage of confidential information.
(6) The information processing method according to any one of (3) to (5) above may further include turning off the flag when the transmission of a mask image is ended.

According to this configuration, when transmission of a mask image is ended, the flag can be switched from on to off.

Further, the present disclosure can be implemented not only as an information processing method for executing the characteristic processing as described above, but also as an information processing device or the like having a characteristic configuration corresponding to characteristic processing executed by the information processing method. Further, the present disclosure can also be implemented as a computer program that causes a computer to execute characteristic processing included in the information processing method described above. Therefore, even in another aspect below, an effect as in the above information processing method can be achieved.
(7) An information processing device according to another aspect of the present disclosure includes an acquisition part that acquires an image captured by a camera, a mask processing execution part that executes mask processing of creating a mask image in which an area outside a capturable area in the image is masked, a determination part that determines whether or not the mask processing is executed, and a transmission part that transmits the mask image when it is determined that the mask processing is executed.
(8) An information processing program according to another aspect of the present disclosure causes a computer to function to acquire an image captured by a camera, execute mask processing of creating a mask image in which an area outside a capturable area in the image is masked, determine whether or not the mask processing is executed, and transmit the mask image when it is determined that the mask processing is executed.
(9) A non-transitory computer-readable recording medium according to another aspect of the present disclosure records an information processing program, and the information processing program causes a computer to function to acquire an image captured by a camera, execute mask processing of creating a mask image in which an area outside a capturable area in the image is masked, determine whether or not the mask processing is executed, and transmit the mask image when it is determined that the mask processing is executed.

Hereinafter, an embodiment of the present disclosure will be described with reference to the accompanying drawings. Note that each of embodiments to be described below shows one specific example of the present disclosure. Numerical values, shapes, constituent elements, steps, order of steps, and the like of the embodiment below are merely examples, and do not intend to limit the present disclosure. Further, a constituent element not described in an independent claim representing a highest concept among constituent elements in the embodiments below is described as an optional constituent element. Further, in all the embodiments, content of each of the embodiments can be combined.

### First Embodiment

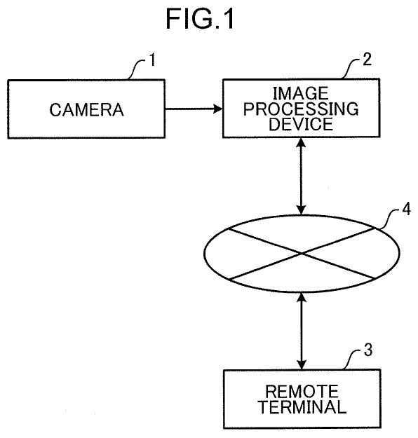

FIG. 1 is a diagram illustrating an example of a configuration of a work support system according to a first embodiment of the present disclosure. The work support system illustrated in FIG. 1 includes a camera 1, an image processing device 2, and a remote terminal 3.

The camera 1 is, for example, a wearable camera mounted on the head of a worker at a site. The worker wears the camera 1 and performs work. At this time, the worker in the site receives business support from a worker in a remote place while capturing a support target device in a work space in the site with the camera 1. The worker in the remote place provides support for operation, repair, and the like of the support target device while viewing an image transmitted from the site.

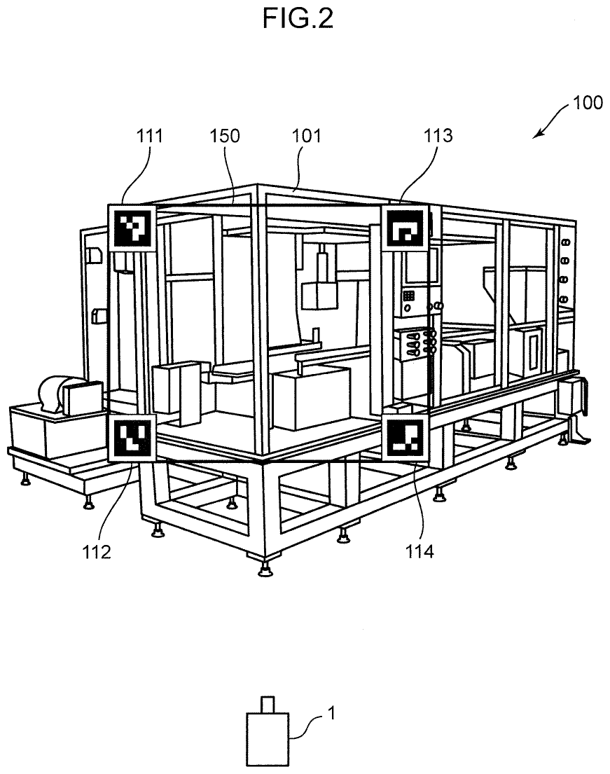

FIG. 2 is a diagram illustrating an example of a work space in the first embodiment.

As illustrated in FIG. 2, a support target device 101 is installed in a work space 100. A worker at a site captures an image of the support target device 101 by using the camera 1. The image captured with the camera 1 is transmitted to the remote terminal 3 operated by a worker in a remote place. At this time, there is a possibility that confidential information appears in the captured image. In view of the above, in order to prevent an image including confidential information from being transmitted, a portion other than a specific work area is hidden by image processing (mask processing). A worker at a site attaches a plurality of markers 111, 112, 113, and 114 in a manner surrounding a work area not including confidential information of the support target device 101. The plurality of markers 111, 112, 113, and 114 are directly attached in a manner surrounding a work area that can be captured, with for example, an adhesive substance, a magnet, or the like.

The camera 1 transmits a captured image to the image processing device 2 by short range wireless communication. The camera 1 transmits an image to the image processing device 2 at a predetermined frame rate. For this reason, a moving image is transmitted from the camera 1 to the image processing device 2. Note that the camera 1 is wirelessly connected to the image processing device 2, but may be connected to the image processing device 2 via wired connection.

Note that the camera 1 may be a terminal with a camera such as a smartphone or a tablet computer. Further, the camera 1 may be a digital camera.

The image processing device 2 is, for example, a personal computer operated by a worker at a site. The image processing device 2 is connected to the remote terminal 3 via a network 4 so as to be able to communicate with each other. The network 4 is the Internet, for example.

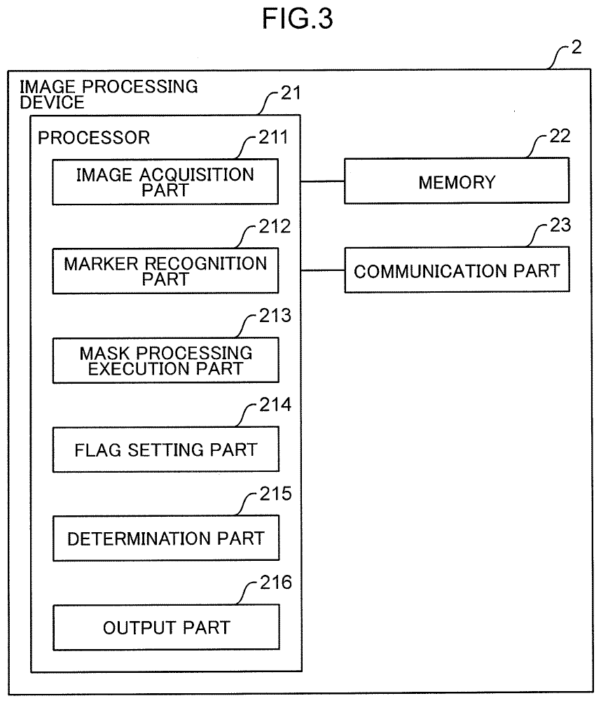

FIG. 3 is a diagram illustrating an example of a configuration of the image processing device 2 according to the first embodiment.

The image processing device 2 illustrated in FIG. 3 includes a processor 21, a memory 22, and a communication part 23.

The processor 21 is a central processing unit (CPU), for example. The processor 21 realizes an image acquisition part 211, a marker recognition part 212, a mask processing execution part 213, a flag setting part 214, a determination part 215, and an output part 216.

The memory 22 is a storage device that can store various types of information, such as a random access memory (RAM), a hard disk drive (HDD), a solid state drive (SSD), or a flash memory.

Note that the image processing device 2 corresponds to an example of an information processing device, the image acquisition part 211 corresponds to an example of an acquisition part, the marker recognition part 212 corresponds to an example of a recognition part, the mask processing execution part 213 corresponds to an example of a mask processing execution part, the determination part 215 corresponds to an example of a determination part, and the communication part 23 corresponds to an example of a transmission part.

The communication part 23 receives an image transmitted by the camera 1. The communication part 23 outputs a received image to the processor 21. The communication part 23 receives a moving image transmitted at a predetermined frame rate, and outputs an image to the processor 21 for each frame.

The image acquisition part 211 acquires an image captured by the camera 1. The image acquisition part 211 acquires an image for each frame.

The marker recognition part 212 recognizes a plurality of markers included in an image acquired by the image acquisition part 211. In the first embodiment, four markers 111, 112, 113, and 114 of different types are used. As illustrated in FIG. 2, the four markers 111, 112, 113, and 114 have a rectangular shape and have different patterns.

A worker at a site attaches the marker 111 on the upper left of a work area 150 that can be captured, attaches the marker 112 on the lower left of the work area 150 that can be captured, attaches the marker 113 on the upper right of the work area 150 that can be captured, and attaches the marker 114 on the lower right of the work area 150 that can be captured. Note that positions at which the four markers 111, 112, 113, and 114 are arranged are not particularly determined. The four markers 111, 112, 113, and 114 may be arranged at any of the upper left, the lower left, the upper right, and the lower right of the work area 150 that can be captured.

The marker recognition part 212 recognizes the four markers 111, 112, 113, and 114 included in an image by pattern matching. That is, the marker recognition part 212 recognizes the four markers 111, 112, 113, and 114 in an image by collating patterns of a plurality of markers stored in advance in the memory 22 with patterns of the four markers 111, 112, 113, and 114 included in the image.

Note that the marker recognition part 212 can recognize not only a marker captured from the front but also a marker captured from an oblique direction.

Further, in the first embodiment, four markers are used, but the present disclosure is not particularly limited to this, and three markers may be used, or five or more markers may be used.

The mask processing execution part 213 executes mask processing of creating a mask image in which an area outside a capturable area in an image is masked. In the mask processing, a plurality of markers included in an image are recognized, and a mask image in which an area outside a capturable area surrounded by the plurality of recognized markers in the image is masked is created.

When the plurality of markers 111, 112, 113, and 114 are recognized by the marker recognition part 212, the mask processing execution part 213 identifies a capturable area surrounded by the plurality of markers 111, 112, 113, and 114 that are recognized. That is, when all of the plurality of markers 111, 112, 113, and 114 are recognized, the mask processing execution part 213 identifies a capturable area surrounded by the plurality of markers 111, 112, 113, and 114 that are recognized.

When the four markers 111, 112, 113, and 114 are recognized, the mask processing execution part 213 identifies a capturable area in which an upper left vertex of the marker 111 on the upper left, a lower left vertex of the marker 112 on the lower left, an upper right vertex of the marker 113 on the upper right, and a lower right vertex of the marker 114 on the lower right are connected by a straight line.

Note that when the four markers 111, 112, 113, and 114 are recognized, the mask processing execution part 213 may identify a capturable area in which a lower right vertex of the marker 111 on the upper left, an upper right vertex of the marker 112 on the lower left, a lower left vertex of the marker 113 on the upper right, and an upper left vertex of the marker 114 on the lower right are connected by a straight line. Further, when the four markers 111, 112, 113, and 114 are recognized, the mask processing execution part 213 may identify a capturable area in which center points of four of the markers 111, 112, 113, and 114 are connected by a straight line.

Further, when all of the plurality of markers are not recognized, the mask processing execution part 213 does not identify a capturable area. The number of a plurality of markers is determined in advance, and in the first embodiment, the number of the plurality of markers is four. The mask processing execution part 213 identifies a capturable area when all four markers are recognized, and does not identify a capturable area when only three or less markers are recognized.

The mask processing execution part 213 creates a mask image in which an area outside an identified capturable area in an image is masked. When a capturable area is not identified, the mask processing execution part 213 may create a mask image in which the entire image is masked.

After the mask processing is first executed, the flag setting part 214 turns on a transmission permission flag indicating that a mask image can be transmitted. The memory 22 stores the transmission permission flag. The flag setting part 214 turns on the transmission permission flag stored in the memory 22 after the mask processing is first executed. Further, when ending transmission of a mask image, the flag setting part 214 turns off the transmission permission flag stored in the memory 22.

The determination part 215 determines whether or not mask processing is executed by the mask processing execution part 213. Here, the determination part 215 determines whether or not the transmission permission flag is on. When determining that the transmission permission flag is turned on, the determination part 215 determines that the mask processing is executed. Further, when determining that the transmission permission flag is not turned on, that is, when determining that the transmission permission flag is turned off, the determination part 215 determines that the mask processing is not executed.

When the determination part 215 determines that the mask processing is executed, the output part 216 transmits a mask image. When the determination part 215 determines that the mask processing is executed, the output part 216 transmits a mask image created by the mask processing execution part 213 to the remote terminal 3 via the communication part 23. The communication part 23 transmits a mask image to the remote terminal 3. Further, when the determination part 215 determines that the mask processing is not executed, the output part 216 does not transmit a mask image.

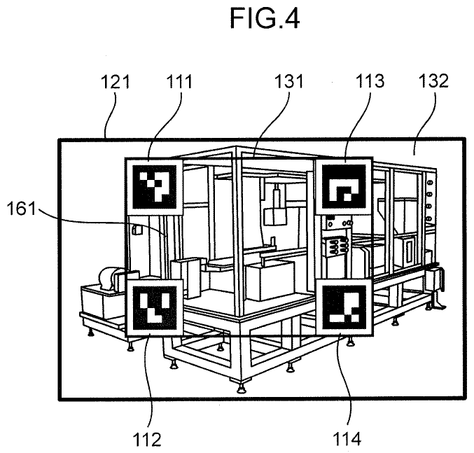

FIG. 4 is a diagram illustrating an example of an image 121 captured by the camera 1 in a manner that all markers appear in the first embodiment. Note that in FIG. 4, a marker is illustrated to be larger than an actual marker for easy understanding of description.

The image 121 includes all of the four markers 111, 112, 113, and 114. The marker recognition part 212 recognizes the four markers 111, 112, 113, and 114 included in the image 121 acquired by the image acquisition part 211. When all of the four markers 111, 112, 113, and 114 are recognized, the mask processing execution part 213 identifies a capturable area 131 surrounded by the four markers 111, 112, 113, and 114 that are recognized.

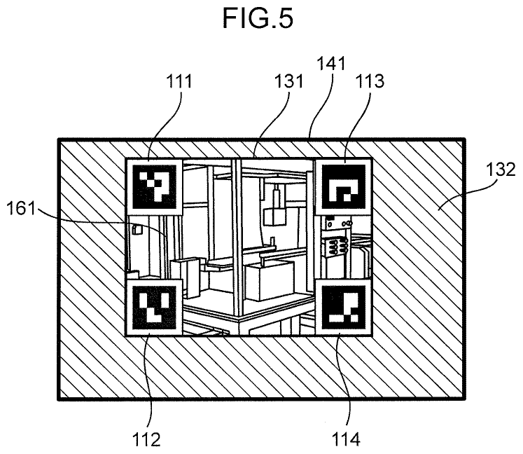

FIG. 5 is a diagram illustrating an example of a mask image 141 created based on the image 121 illustrated in FIG. 4 in the first embodiment.

The mask processing execution part 213 creates the mask image 141 in which an area 132 outside the capturable area 131 in the image 121 is masked. The mask processing execution part 213 performs the mask processing on the area 132 outside the capturable area 131 in the image 121. The mask processing may be, for example, processing of filling the area 132 with a predetermined color such as black, white, or gray, processing of applying blurring processing to the area 132, or processing of applying mosaic processing to the area 132. In the mask image 141 illustrated in FIG. 5, a capturable image 161 in the capturable area 131 is visually recognizable, and the area 132 other than the capturable area 131 is concealed.

Further, when the four markers 111, 112, 113, and 114 are first recognized and the mask processing is first executed, the flag setting part 214 turns on the transmission permission flag indicating that a mask image can be transmitted.

Note that, in the first embodiment, the image processing device 2 is arranged in a site, but the present disclosure is not particularly limited to this, and the image processing device 2 may be a server provided on a cloud. In this case, the image processing device 2 is connected to the camera 1 via the network 4 so as to be able to communicate with each other.

The remote terminal 3 is, for example, a personal computer, a smartphone, or a tablet computer operated by a worker in a remote place. The remote terminal 3 receives a mask image transmitted by the image processing device 2. The remote terminal 3 displays the received mask image. The image processing device 2 transmits a mask image to the remote terminal 3 at a predetermined frame rate. For this reason, a moving image is transmitted from the image processing device 2 to the remote terminal 3.

A worker in a remote place can support work of a worker at a site while viewing a mask image displayed on the remote terminal 3. Note that the image processing device 2 and the remote terminal 3 may transmit and receive not only image data but also audio data to and from each other.

Next, work support processing by the image processing device 2 according to the first embodiment of the present disclosure will be described.

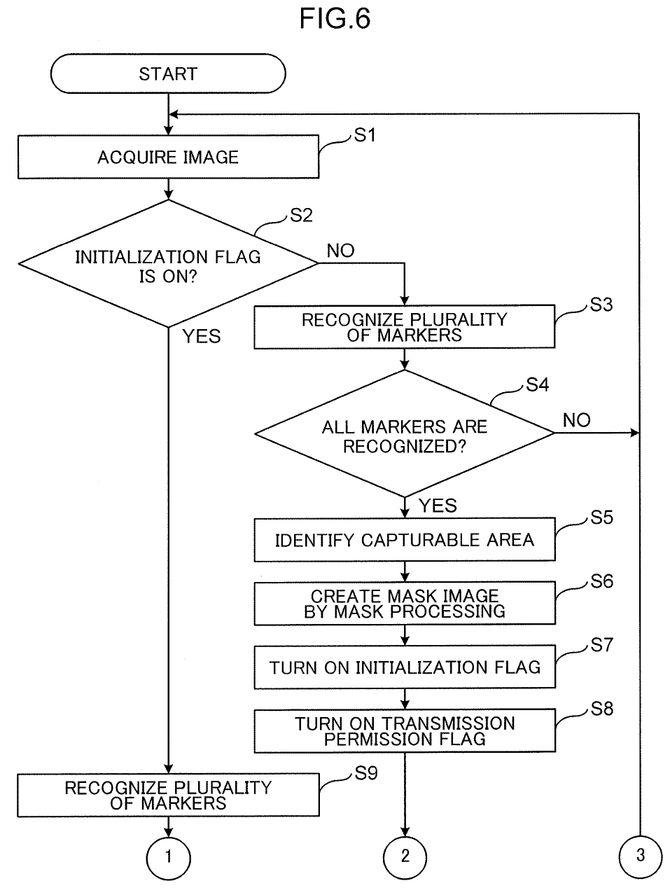

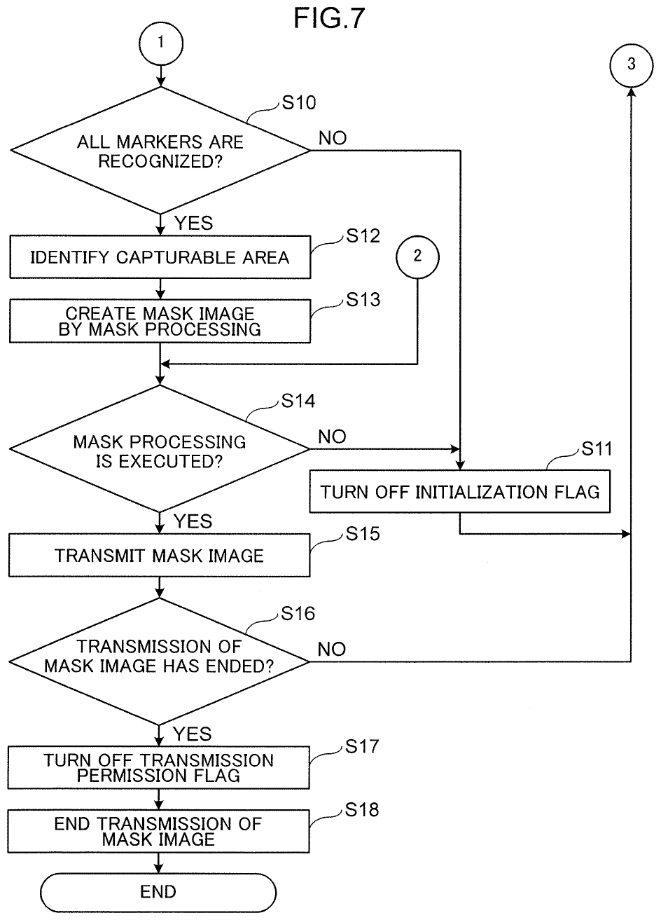

FIG. 6 is a first flowchart for explaining the work support processing by the image processing device 2 according to the first embodiment of the present disclosure, and FIG. 7 is a second flowchart for explaining the work support processing by the image processing device 2 according to the first embodiment of the present disclosure.

First, in Step S1, the image acquisition part 211 acquires an image captured by the camera 1. Note that when the camera 1 is powered on or when a button for starting transmission of a mask image provided in the image processing device 2 is pressed, an image is acquired from the camera 1.

Next, in Step S2, the marker recognition part 212 determines whether or not an initialization flag stored in the memory 22 is on. Here, when it is determined that the initialization flag is not on, that is, the initialization flag is off (NO in Step S2), in Step S3, the marker recognition part 212 recognizes a plurality of markers included in an image acquired by the image acquisition part 211.

Next, in Step S4, the mask processing execution part 213 determines whether or not all the markers are recognized by the marker recognition part 212. Note that the number of a plurality of markers used for image recognition is determined in advance. The memory 22 stores the number of the plurality of markers in advance. In the first embodiment, the number of the plurality of markers is four. The mask processing execution part 213 determines whether or not four markers are recognized by the marker recognition part 212.

Here, when it is determined that all the markers are not recognized, that is, when it is determined that at least one of the plurality of markers is not recognized (NO in Step S4), the processing returns to Step S1.

On the other hand, when it is determined that all the markers are recognized (YES in Step S4), in Step S5, the mask processing execution part 213 identifies a capturable area surrounded by the plurality of markers recognized by the marker recognition part 212.

Next, in Step S6, the mask processing execution part 213 creates a mask image by the mask processing of masking an area outside the identified capturable area in the image.

Next, in Step S7, the flag setting part 214 turns on an initialization flag stored in the memory 22.

Next, in Step S8, the flag setting part 214 turns on the transmission permission flag stored in the memory 22. After the transmission permission flag is turned on, the processing proceeds to Step S14.

On the other hand, when it is determined that the initialization flag is on (YES in Step S2), in Step S9, the marker recognition part 212 recognizes the plurality of markers included in the image acquired by the image acquisition part 211.

Next, in Step S10, the mask processing execution part 213 determines whether or not all the markers are recognized by the marker recognition part 212.

Here, when it is determined that all the markers are not recognized, that is, when it is determined that at least one of the plurality of markers is not recognized (NO in Step S10), the flag setting part 214 turns off the initialization flag stored in the memory 22 in Step S11. After the initialization flag is turned off, the processing returns to Step S1.

On the other hand, when it is determined that all the markers are recognized (YES in Step S10), in Step S12, the mask processing execution part 213 identifies a capturable area surrounded by the plurality of markers recognized by the marker recognition part 212.

Next, in Step S13, the mask processing execution part 213 creates a mask image by mask processing of masking an area outside the identified capturable area in the image.

Next, in Step S14, the determination part 215 determines whether or not the mask processing is executed. At this time, the determination part 215 determines whether or not the transmission permission flag stored in the memory 22 is on. When determining that the transmission permission flag is on, the determination part 215 determines that the mask processing is executed. When determining that the transmission permission flag is not on, the determination part 215 determines that the mask processing is not executed.

Here, when it is determined that the mask processing is not executed, that is, when it is determined that the transmission permission flag is off (NO in Step S14), the mask image is not transmitted, and the processing proceeds to Step S11.

On the other hand, when it is determined that the mask processing is executed, that is, when it is determined that the transmission permission flag is on (YES in Step S14), in Step S15, the output part 216 transmits the mask image created by the mask processing execution part 213 to the remote terminal 3 via the communication part 23. The remote terminal 3 receives a mask image transmitted by the image processing device 2. The remote terminal 3 displays the received mask image.

Next, in Step S16, the output part 216 determines whether or not to end the transmission of a mask image. Note that, when power of the camera 1 is turned off, or when a button for ending transmission of ae mask image provided in the image processing device 2 is pressed, the transmission of a mask image ends.

Here, when it is determined that the transmission of a mask image is ended (YES in Step S16), the flag setting part 214 turns off the transmission permission flag stored in the memory 22 in Step S17.

Next, in Step S18, the output part 216 ends the transmission of a mask image.

On the other hand, when it is determined that the transmission of a mask image is not ended (NO in Step S16), the processing returns to Step S1.

As described above, after the mask processing of creating a mask image in which an area outside a capturable area in an image is masked is executed, it is determined whether or not the mask processing is executed. Then, when it is determined that the mask processing is executed, the created mask image is transmitted. Therefore, leakage of confidential information can be prevented.

### Second Embodiment

In the first embodiment, after the mask processing is first executed, the transmission permission flag indicating that a mask image can be transmitted is automatically turned on. On the other hand, in a second embodiment, after the mask processing is first executed, a created mask image is displayed, and an instruction indicating whether or not the mask processing is normally executed input by a worker is received. Then, when an instruction indicating that the mask processing is normally executed input by a worker is received, the transmission permission flag indicating that a mask image can be transmitted is turned on.

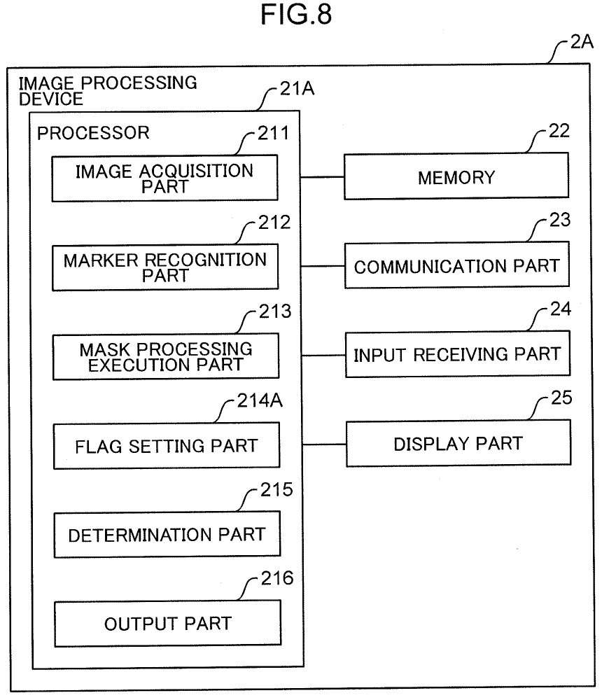

FIG. 8 is a diagram illustrating an example of a configuration of an image processing device 2A according to the second embodiment. Note that in the second embodiment, a configuration of the work support system other than the image processing device 2A is the same as that of the work support system in the first embodiment.

The image processing device 2A illustrated in FIG. 8 includes a processor 21A, the memory 22, the communication part 23, an input receiving part 24, and a display part 25. Note that, in the second embodiment, the same configuration as that in the first embodiment will be denoted by the same reference sign as that in the first embodiment, and will be omitted from description.

The processor 21A realizes the image acquisition part 211, the marker recognition part 212, the mask processing execution part 213, a flag setting part 214A, the determination part 215, and the output part 216.

The display part 25 is, for example, a liquid crystal display device. The display part 25 displays a mask image created by the mask processing execution part 213 after the mask processing is first executed by the mask processing execution part 213. A worker visually checks the mask image displayed on the display part 25 and checks whether or not the mask processing is normally executed.

The input receiving part 24 is, for example, a keyboard, a mouse, or a touch panel. The input receiving part 24 receives an instruction indicating whether or not the mask processing is normally executed input by a worker. The input receiving part 24 includes a first button for instructing that the mask processing is normally executed and a second button for instructing that the mask processing is not normally executed. A worker checks a mask image displayed on the display part 25. Then, when determining that the mask processing is normally executed, a worker presses the first button, and when determining that the mask processing is not normally executed, a worker presses the second button.

Note that the first button and the second button may be displayed on the display part 25. A worker may move a cursor on a screen onto the first button or the second button by using a mouse and click a button of the mouse. Further, when the display part 25 is a touch panel, a worker may touch either the first button or the second button on a screen.

When an instruction indicating that the mask processing is normally executed input by a worker is received, the flag setting part 214A turns on the transmission permission flag indicating that a mask image can be transmitted. Further, when an instruction indicating that the mask processing is not normally executed input by a worker is received, the flag setting part 214A turns off the transmission permission flag.

The determination part 215 determines whether or not the transmission permission flag is on. When determining that the transmission permission flag is turned on, the determination part 215 determines that the mask processing is executed. Further, when determining that the transmission permission flag is off, the determination part 215 determines that the mask processing is not executed.

When the determination part 215 determines that the mask processing is not executed, the output part 216 does not transmit a mask image.

Next, work support processing by the image processing device 2A according to the second embodiment of the present disclosure will be described.

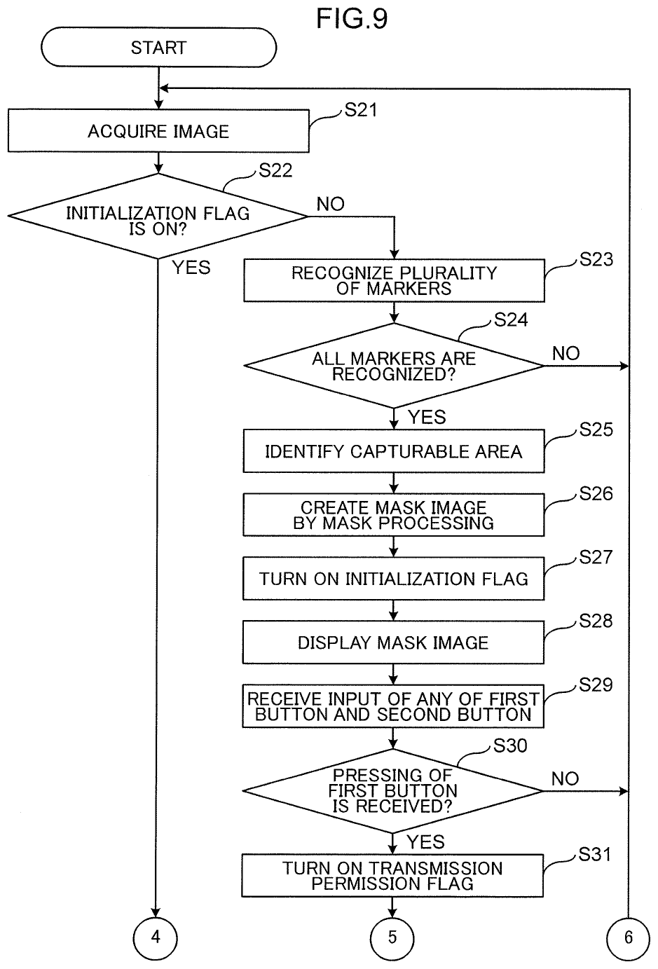

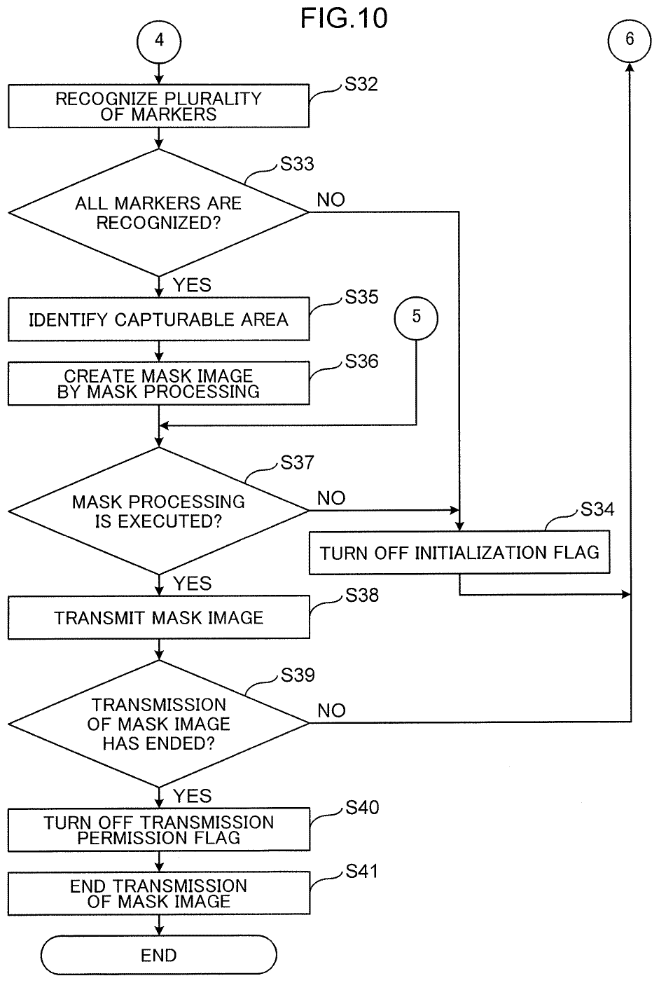

FIG. 9 is a first flowchart for explaining the work support processing by the image processing device 2A according to the second embodiment of the present disclosure, and FIG. 10 is a second flowchart for explaining the work support processing by the image processing device 2A according to the second embodiment of the present disclosure.

The processing of Steps S21 to S27 is the same as the processing of Steps S1 to S7 shown in FIG. 6, and will be omitted from description.

Next, in Step S28, the display part 25 displays the mask image created by the mask processing execution part 213. By the above, the mask image obtained by performing the mask processing on an acquired image is presented to a worker.

Next, in Step S29, the input receiving part 24 receives input by a worker of one of the first button for instructing that the mask processing is normally executed and the second button for instructing that the mask processing is not normally executed. A worker checks the displayed mask image, and presses the first button when the mask processing is normally executed, that is, when confidential information in the mask image is masked. On the other hand, when the mask processing is not normally executed, that is, when confidential information in the mask image is not masked, a worker presses the second button.

Next, in Step S30, the flag setting part 214A determines whether or not pressing of the first button is received by the input receiving part 24.

Here, when it is determined that pressing of the first button is not received, that is, when it is determined that pressing of the second button is received (NO in Step S30), the processing returns to Step S21. Note that, at this time, the flag setting part 214A turns off the transmission permission flag stored in the memory 22. Further, when the initial transmission permission flag is off, the flag setting part 214A may keep the transmission permission flag off.

On the other hand, when it is determined that pressing of the first button is received (YES in Step S30), the flag setting part 214A turns on the transmission permission flag stored in the memory 22 in Step S31. After the transmission permission flag is turned on, the processing proceeds to Step S37.

On the other hand, when it is determined that the initialization flag is on (YES in Step S22), in Step S32, the marker recognition part 212 recognizes a plurality of markers included in the image acquired by the image acquisition part 211.

Note that the processing of Steps S32 to S41 is the same as the processing of Steps S9 to S18 illustrated in FIGS. 6 and 7, and thus will be omitted from description.

As described above, a worker checks whether or not the mask processing is normally executed by viewing the displayed mask image, and thus, it is possible to reliably prevent leakage of confidential information.

Note that, in the first and second embodiments, the mask processing execution part 213 recognizes a plurality of markers included in an image, and executes mask processing of creating a mask image in which an area outside a capturable area surrounded by the plurality of recognized markers in the image is masked. However, the present disclosure is not particularly limited to this, and first mask processing to third mask processing below may be executed.

In the first mask processing, when an image is first acquired, the input receiving part 24 may receive input by a worker for designating a capturable area in the image. In this case, by a user interface, a capturable area in the image may be surrounded so that the capturable area is designated. Then, the mask processing execution part 213 may store a capturable image in the capturable area received by the input receiving part 24 in the memory 22 as an initial capturable image. After the above, the mask processing execution part 213 may compare the initial capturable image with a currently acquired image and identify an area in an image that coincides with the initial capturable image as a capturable area. At this time, the mask processing execution part 213 may extract a plurality of feature points of the initial capturable image, extract a plurality of feature points of the currently acquired image, associate the plurality of feature points of the initial capturable image with the plurality of feature points of the currently acquired image, and identify an area in the image having the same feature points as the plurality of feature points of the initial capturable image as a capturable area.

Note that, after an initial capturable image is first stored in the memory 22, the mask processing execution part 213 may compare a capturable image in an image one frame before with a currently acquired image for each frame, and estimate an area in an image coinciding with the capturable image one frame before as a capturable area. Then, the mask processing execution part 213 may identify the estimated capturable area as a capturable area of the acquired image.

In the second mask processing, similarly to the first mask processing, when an image is first acquired, the input receiving part 24 may receive input by a worker for designating a capturable area in the image. The camera 1 may further include a first sensor that detects a position and a posture of the camera 1. The first sensor is, for example, an acceleration sensor and a gyro sensor, and detects translational motion (x, y, and z) and rotational motion (roll angle, pitch angle, and yaw angle) in three axis directions of the camera 1. The camera 1 may transmit an image to the image processing device 2 or 2A, and may transmit a first sensing value representing a position and posture of the camera 1 detected by the first sensor to the image processing device 2 or 2A. The processor 21 or 21A may include a sensing value acquisition part. The sensing value acquisition part may acquire the first sensing value representing a position and posture of the camera 1 for each frame. Then, the mask processing execution part 213 may store a capturable image in a capturable area received by the input receiving part 24 in the memory 22 as an initial capturable image, and store the first sensing value representing a position and posture of the camera 1 in the memory 22 as a first initial sensing value.

Then, the mask processing execution part 213 may calculate a current position and a current posture of the camera 1 relative to an initial position and an initial posture of the camera 1 represented by the first initial sensing value, and identify a capturable area based on a calculation result. The mask processing execution part 213 may estimate a current capturing range of the camera 1 with respect to an initial capturable image from an initial position and an initial posture of the camera 1 and a current position and a current posture of the camera 1. The mask processing execution part 213 may identify an area in a currently acquired image that coincides with an initial capturable image as a capturable area from a current capturing range with respect to the initial capturable image.

That is, a moving direction and a moving distance from an initial position and an initial posture of the camera 1 are calculated from the first initial sensing value and a current first sensing value. Then, a current position and a current posture of the camera 1 are estimated from the calculated moving direction and moving distance. A current capturing range of the camera 1 with respect to an initial capturable image is estimated from the estimated current position and current posture of the camera 1, and an area in a currently acquired image, which coincides with the initial capturable image, is identified as a capturable area.

Note that the mask processing execution part 213 may acquire a first sensing value one frame before and a current first sensing value. Based on a current position and a current posture of the camera 1 with respect to a position and a posture of the camera 1 one frame before, which are estimated based on a first sensing value one frame before and a current first sensing value, the mask processing execution part 213 may identify, as a capturable area, an area in a currently acquired image, which coincides with a capturable image one frame before.

In the third mask processing, similarly to the first mask processing, when an image is first acquired, the input receiving part 24 may receive input by a worker for designating a capturable area in the image. The camera 1 may further include a second sensor that detects a distance from the camera 1 to an object for each pixel in an image. The second sensor is, for example, a depth sensor. The camera 1 may transmit a second sensing value indicating a distance from the camera 1 to an object for each pixel in an image to the image processing device 2 or 2A together with the image. When an image is first acquired, the mask processing execution part 213 may store a capturable image in a capturable area in the image in the memory 22 as an initial capturable image, and store each distance from the camera 1 to an object for each pixel in the initial capturable image in the memory 22 as a second initial sensing value. The mask processing execution part 213 may acquire a second initial sensing value and a second sensing value indicating a distance from the camera 1 to an object for each pixel in a currently acquired image. Then, the mask processing execution part 213 may identify, as a capturable area, an area in which second sensing values of a plurality of pixels in the currently acquired image are equal to or less than a longest distance among second initial sensing values.

The mask processing execution part 213 may identify a capturable area by using a first sensing value or may identify a capturable area by using a second sensing value. Further, the mask processing execution part 213 may identify a capturable area by using both a first sensing value and a second sensing value. In this case, the mask processing execution part 213 may calculate a logical product of a capturable area identified by using a first sensing value and a capturable area identified by using a second sensing value.

Further, the mask processing execution part 213 may combine any two of the first mask processing, the second mask processing, and the third mask processing, or may combine all the three.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. Further, a program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Further, circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Further, some or all functions of the devices according to the embodiments of the present disclosure may be realized by a processor such as a CPU executing a program.

Further, all numbers used above are illustrated to specifically describe the present disclosure, and the present disclosure is not limited to the illustrated numbers.

Further, order in which steps illustrated in the above flowchart are executed is for specifically describing the present disclosure, and may be any order other than the above order as long as a similar effect is obtained. Further, some of the above steps may be executed simultaneously (in parallel) with other steps.

Since the technique according to the present disclosure can prevent leakage of confidential information, the technique according to the present disclosure is useful as a technique for masking an area other than a capturable area in an image.

1. An information processing method in a computer, the information processing method comprising:
acquiring an image captured by a camera;
executing mask processing of creating a mask image in which an area outside a capturable area in the image is masked;
determining whether or not the mask processing is executed; and
transmitting the mask image when it is determined that the mask processing is executed.

2. The information processing method according to claim 1, wherein
the mask processing includes:
recognizing a plurality of markers included in the image; and
creating a mask image in which an area outside the capturable area surrounded by the plurality of markers that are recognized in the image is masked.

3. The information processing method according to claim 1, further comprising:
turning on a flag indicating that the mask image can be transmitted after the mask processing is first executed,
wherein in the determining whether or not the mask processing is executed, whether or not the flag is on is determined, and when it is determined that the flag is on, it is determined that the mask processing is executed.

4. The information processing method according to claim 1, further comprising:
displaying the mask image that is created after the mask processing is first executed;
receiving an instruction indicating whether or not the mask processing is normally executed input by a worker; and
turning on a flag indicating that the mask image can be transmitted when an instruction indicating that the mask processing is normally executed input by the worker is received,
wherein in the determining whether or not the mask processing is executed, whether or not the flag is on is determined, and when it is determined that the flag is on, it is determined that the mask processing is executed.

5. The information processing method according to claim 4, further comprising:
turning off the flag when an instruction indicating that the mask processing is not normally executed input by the worker is received,
wherein in the determining whether or not the mask processing is executed, whether or not the flag is on is determined, and when it is determined that the flag is off, it is determined that the mask processing is not executed, and
in the transmitting a mask image, when it is determined that the mask processing is not executed, the mask image is not transmitted.

6. The information processing method according to claim 3, further comprising:
turning off the flag when the transmission of a mask image is ended.

7. The information processing method according to claim 4, further comprising:
turning off the flag when the transmission of a mask image is ended.

8. The information processing method according to claim 5, further comprising:
turning off the flag when the transmission of a mask image is ended.

9. An information processing device comprising:
an acquisition part that acquires an image captured by a camera;
a mask processing execution part that executes mask processing of creating a mask image in which an area outside a capturable area in the image is masked;
a determination part that determines whether or not the mask processing is executed; and
a transmission part that transmits the mask image when it is determined that the mask processing is executed.

10. A non-transitory computer readable recording medium storing an information processing program that causes a computer to function to:
acquire an image captured by a camera;
execute mask processing of creating a mask image in which an area outside a capturable area in the image is masked;
determine whether or not the mask processing is executed; and
transmit the mask image when it is determined that the mask processing is executed.
